(19) United States
(12) Patent Application Publication
(10) Pub. No.: US 2014/0336550 A1
(43) Pub. Date: Nov. 13, 2014

(54) Rolling Ball Massager

(71) Applicant: James E. Zedaker, Phoenix, AZ (US)

(72) Inventor: James E. Zedaker, Phoenix, AZ (US)

(21) Appl. No.: 13/918,157

(22) Filed: Jun. 14, 2013

Related U.S. Application Data
(60) Provisional application No. 61/661,004, filed on Jun. 18, 2012.

(51) Int. Cl. A61H 15/00

(52) U.S. Cl. CPC A61H 15/00
USPC 601/131

(57) ABSTRACT

The invention is an improved rolling ball massager that employs two opposing bearing rings a fixed distance apart to enable free rotation of the housed ball in all directions and under all ordinary massage conditions. A cap over the ball may be adopted to allow the user to apply more pressure on the massager. A handle can be removeably coupled to the cap. The handle may provide a grip and additional therapy value with various features, such as winged tips and arc contours. The handle may be centric or offset on the cap. The massager may have protrusions designed to provide pressure point therapy surfaces. Moreover, the massager may have an intermediate member mating the protrusions, such as a lock-ring assembly, for incorporating the massager as a building block for other devices, such as a foot massage floor stand or a back-scratcher device.

### CROSS-REFERENCE TO RELATED APPLICATIONS

The present application claims priority to co-pending U.S. provisional patent application entitled “Improved Rolling Ball Massager,” having Ser. No. 61/661,004, filed on Jun. 18, 2012, which is entirely incorporated herein by reference.

### BACKGROUND

1. Field of the Invention

This invention relates generally to a massage device and in particular to a massage device housing a ball to be used in massage therapy.

2. Description of the Related Art

When you need a massage, you need it now, not in a couple of days when an available appointment can be made. Mechanisms such as the foam roller and trigger point balls for self-massage have become more common with the increase in physical exercise, along with the recession in America. A massage from a therapist can cost on average $50.

Forcing muscle activity in repetitive motions and/or static positions over and over generates tight and injury-prone muscles. Massaging cleanses compressed overburdened muscles returning them to proper lengths while aiding in appropriate recovery.

The foam roller is an excellent device for self-massage, it massages a broad range of muscle fascia at a time, though it requires lying on floor with ample space for the body and device. Trigger Point balls (trigger points are muscle knots underneath the muscle fascia), or other massage aids like household objects including; golf, hand, racquet, tennis, and lacrosse balls can unknot tender muscles that are deeper in muscles that the foam roller can't reach. However, these devices will not alleviate deep trigger points as well as an experienced thumb or knuckle.

Several patents have used balls, especially golf balls, in massage devices. An example is U.S. Patent Publication No. 2010/0087763 by Hane-Karr (“Hane-Karr”). In Hane-Karr, a massage device is disclosed to receive a golf ball in a cavity and allow the ball to move freely within the cavity. However, the Hane-Karr devices lack features to hold the golf ball from falling out of the cavity when the device is removed. Therefore, it is inconvenient when the user tries to massage several different areas, such as the shoulder, the legs, and the back.

U.S. Pat. No. 7,291,120 by Kyoji et al (“Kyoji”) teaches another massage device to use a golf ball to massage. The device in Kyoji has an opening to receive the golf ball and an elastic rim to prevent the ball from falling out of the opening. However, because of the jutting elements all over the device, the user will not likely hold the device hard enough to apply a force sufficient for alleviating deep irritated points.

Japanese Patent Publication No. JPH079344U by Yoshima Iwasaki (“Iwasaki”) teaches a massage device which holds a golf ball on the upper portion by a peripheral rim and the lower portion by one or more jutting elements. However, the device merely serves a single purpose—massaging with the golf ball, which makes the device less appealing to the consumers.

Therefore, it is desired to have an affordable massage device with a ball to massage a broad range of muscle fascia and deep trigger points. It is also desired that the ball is not removed from the device. Furthermore, it is desired that the massage device has massaging features in addition to the ball.

### SUMMARY OF THE INVENTION

The invention is summarized below only for purposes of introducing embodiments of the invention. The ultimate scope of the invention is to be limited only to the claims that follow the specification.

Generally, the invention includes an improved free-rolling ball massager. The preferred massager comprises at least four elements: (1) a rigid sphere (or a ball), (2) a first bearing ring, which is located on one side of an imaginary plane running through the center point of the sphere, (3) a second bearing ring located on the other side of the imaginary plane, opposing the first bearing ring, and (4) a ring-spacer concentrically holding the two rings a fixed distance apart from each other. These two opposing bearing rings, if configured correctly, permit free rotation of the housed ball in all directions and under all ordinary massage conditions.

Together the two bearing rings and the ring-spacer create a structure that houses the sphere (collectively referred to herein as the “housing structure”). The preferred housing structure (1) exposes a surface region of the ball for contacting the skin or clothing of a massage patient and (2) provides a place for the user to grip the massager. Thus, in operation, a user grips the housing structure with the user's fingers and massages a patient with an exposed surface of the ball.

Alternate embodiments with a structural canopy (cap) or integrated handles create a different grip profiles and create additional deep tissue therapy possibilities.

Other alternate embodiments provide for a pressure attachment, preferably in the form of a handle.

It is an object of this invention to enable self-massage for a specific range of muscle fascia using the free flowing rotation of a ball, preferably a ball with pitted surface such as a golf ball.

It is an object of this invention to make massage easier and more effective by the addition of dorsal fitted grips.

It is an object of this invention to enable massage in a variety of positions, including standing, sitting, or lying down.

It is an object of this invention to enable the breaking up of deep knots by using one of the interchangeable handles to compress different vicinities of muscle trigger points.

It is an object of this invention that, with only basic knowledge of muscle anatomy, one can use the invention to help with injuries, like muscle strains that may not respond to other self-massage devices, as well as alleviate smaller muscles that cramp in the hands from typing, and feet from standing for long durations at work or at home.

It is an object of this invention to stimulate blood flow and break up scar tissue, thus reducing muscle pain and risk of injury, along improving daily and active performance by using the massager in combination with the optional grips.

### BRIEF DESCRIPTION OF THE DRAWINGS

FIG. 1 is a top view of an embodiment of the invention 10 showing a ball 20 and housing 55. The housing 55 in FIG. 1 also acts as bearing ring-spacer 50.

FIG. 2 is a side view of FIG. 1.

FIG. 3 is the side view of FIG. 2 with part of the housing 55 cut-away to illustrate how the first bearing ring 30 and second bearing ring 40 provide opposing bearing surfaces that enclose the ball but permit it to rotate.

FIG. 4 is an enlarged view of part of FIG. 3 showing the interface between the surface of the ball 20 and the bearing surfaces 30, 40.

FIG. 5 is the same view as FIG. 3 with the added structural canopy or cap 70 over on part of the exposed ball so that the user can add more force to the massage.

FIG. 6 is a perspective view of an alternate embodiment with a canopy 70 and knobs 80.

FIG. 7 is the same perspective view as FIG. 6, with the added alternate embodiment of a dorsal handle 100.

FIG. 8 is the same perspective view as FIG. 6, with the added alternate embodiment of an offset dorsal handle 110.

FIG. 9 is an exploded view of an embodiment of the preferred massager 10.

FIG. 10 is an interior cut view of an embodiment of the preferred massager 10.

FIG. 11 is a side view of an embodiment of the lock-ring assembly 90.

FIG. 12 is a top view of the lock-ring assembly 90 shown in FIG. 11.

FIG. 13 is a cut view of the lock-ring assembly 90 showing how it interfaces (removably connects) with knobs 80 of an embodiment of the invention 10.

FIG. 14 is a perspective view of a preferred embodiment of the lock-ring assembly 90.

### DESCRIPTION OF THE EMBODIMENTS

The structure and structural assembly, overall operation and technical characteristics of the present invention will become apparent with the detailed description of a preferred embodiment and the illustration of the related drawings as follows. The invention is defined by the full scope of the drawings, specification and claims.

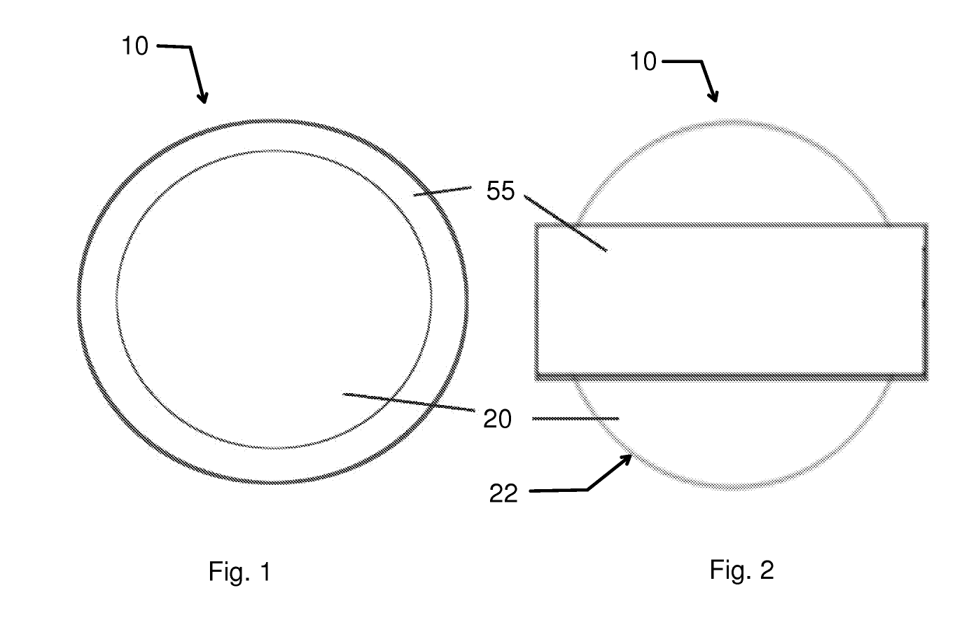

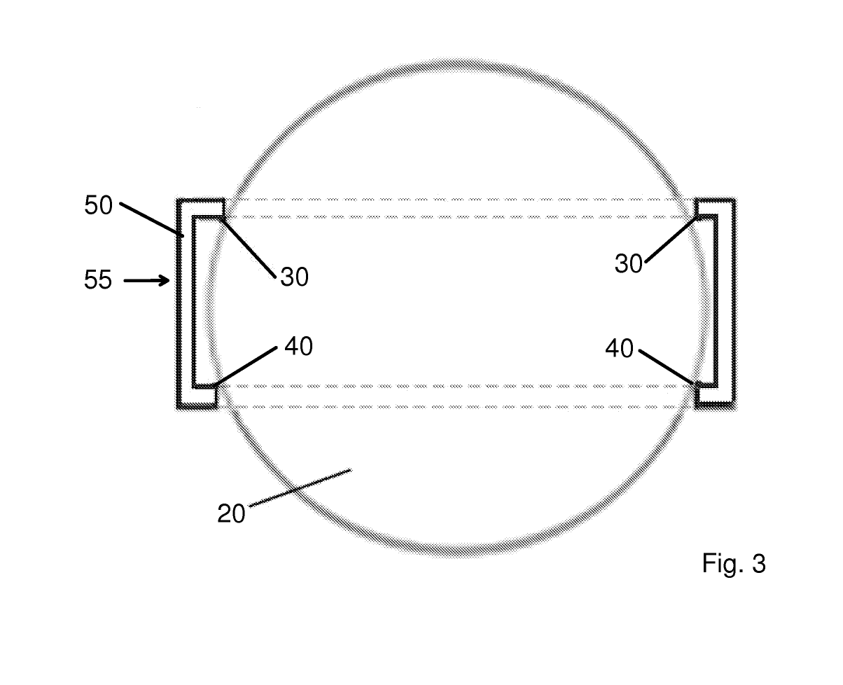

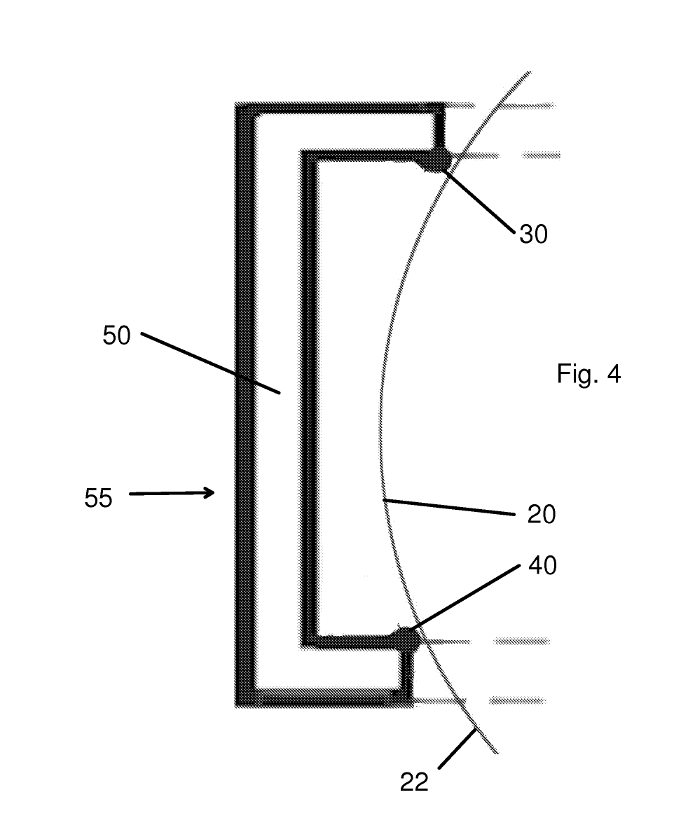

Now, with reference to specific embodiments shown in FIGS. 1-5, the preferred free-rolling ball massager comprises at least four elements: (1) a rigid sphere (or ball) 20, (2) a first bearing ring 30, (3) a second bearing ring 40, and (4) a ring-spacer 50. The first bearing ring 30 is located on one side of an imaginary plane running through the center point of the rigid sphere 20. The second bearing ring 40 is located on the other side of the imaginary plane, opposing the first bearing ring 30.

The ring-spacer 50 concentrically holds the two rings a fixed distance apart from each other. The opposing bearing rings 30, 40, when configured according to this invention, permit free rotation of the housed ball in all directions and, more importantly, under all ordinary massage conditions and pressures.

Together the two bearing rings 30, 40 and the ring-spacer 50 create a structure that houses the sphere (collectively referred to herein as the “housing 55”). Preferably, the housing (1) exposes a surface region 22 of the ball for contacting the skin or clothing of a massage patient and (2) provides a place for the user to grip the massager. Thus, in operation, a user grips the housing 55 with the user's fingers and massages a patient with an exposed surface 22 of the ball.

The housing 55 can be almost any rigid structure as long as it holds opposing bearing rings 30, 40 at a fixed distance from each other on either side of an imaginary plane running through the center point of the ball 20. While ring-spacer 50 is shown as an example in FIGS. 1-5, those in the art will recognize that many suitable structures are possible.

Preferably, opposing bearing rings 30, 40 are rounded (bullnose) circular, parallel, bearing surfaces that effectively cage the ball 20 while also keeping friction between the ball and the rings at a minimum to promote free rolling. Many combinations of ball and bearing rings can work as long as the two are matched to each other. For example, PE plastic has been found to work as bearing surface 30, 40 when matched with a golf ball as the rigid sphere 20.

The preferred housing 55 is made from 10% glass filled polypropylene or similar material. In this way, the housing can be formed in multiple pieces and sonically welded together. Those in the art will, of course, recognize other suitable materials and methods of manufacturing the housing. For example, materials can be joined by other method than sonic welding such as epoxy, mechanical, snap together, electro weld, and thermoset epoxy.

One advantage of using glass-filled polypropylene is that if the massager 10 is chilled/frozen for cold therapy, the heat transfer to ball is relatively slow so the ball 20 does not get warmed by the therapist's hands very quickly.

While many combinations of material types, ball sizes, bearing ring sizes and bearing ring spacing can be used, the following combination is preferred:
the rigid sphere 20 is a golf ball;
the inside diameter of opposing bearing rings 30, 40 is 38 mm;
the fixed distance between bearing rings 30 and 40 is 17.5 mm-18 mm;
the bearing surface width of bearing ring 30, which receives superimposed bearing pressure during a massage, is 3 mm; and
the bearing surface width of bearing ring, which does not receive superimposed bearing pressure during a massage, 40 is 1.5 mm.

Finally, it is preferred that housing 55 be permanently joined so the rigid sphere 20 is not removed during ordinary use of the massager. To facilitate cleaning/drying the massager 10, it is preferred to add a dedicated drain hole to the housing 55.

### ALTERNATE EMBODIMENTS

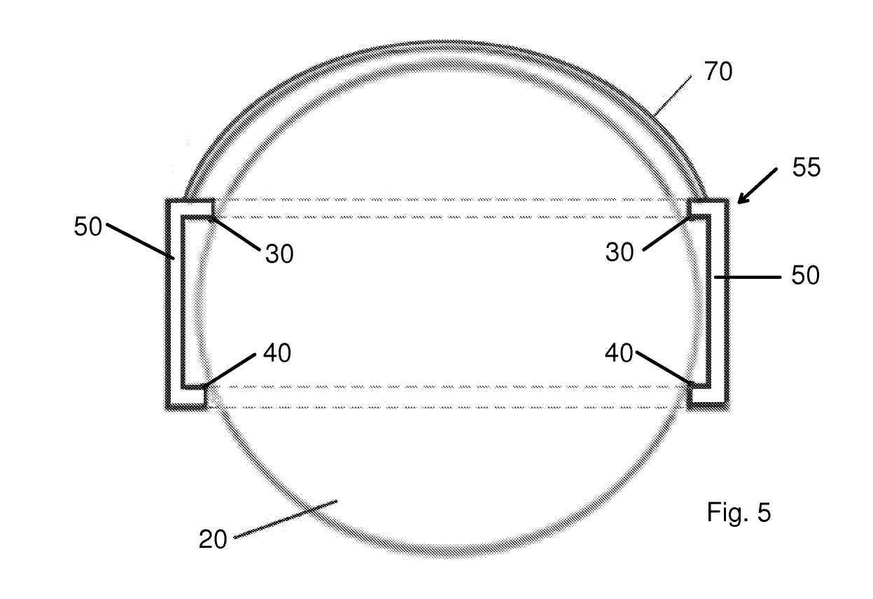

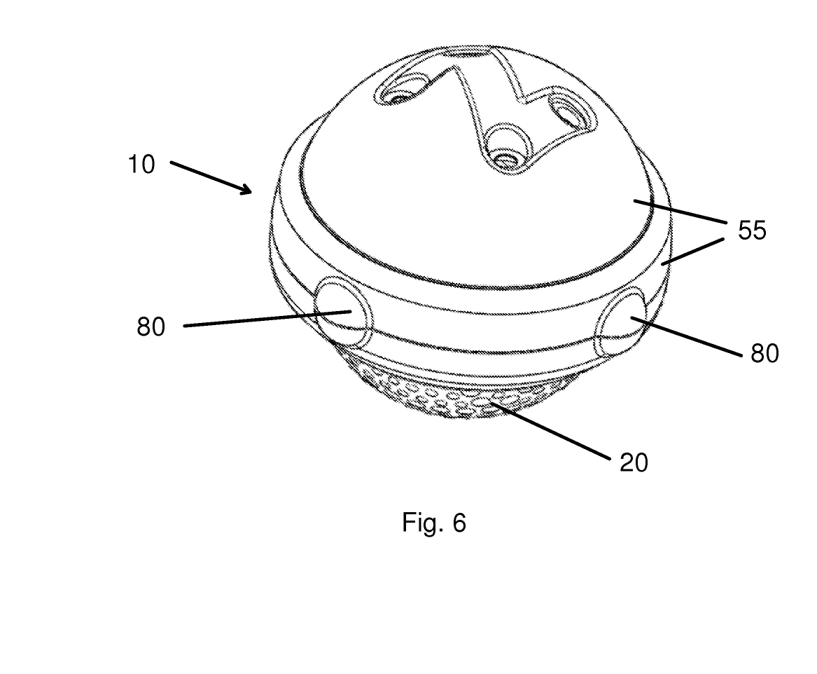

One alternate embodiment is to attach a structural canopy (or cap) 70 over one surface of the ball as shown in FIGS. 5-6. The housing 55 with the canopy 70 enables the practitioner (or user of the massager 10) to apply more pressure on the rolling ball than would be possible with just a ringed housing in FIGS. 1-4.

Another alternate embodiment is to connect a dorsal handle 100.

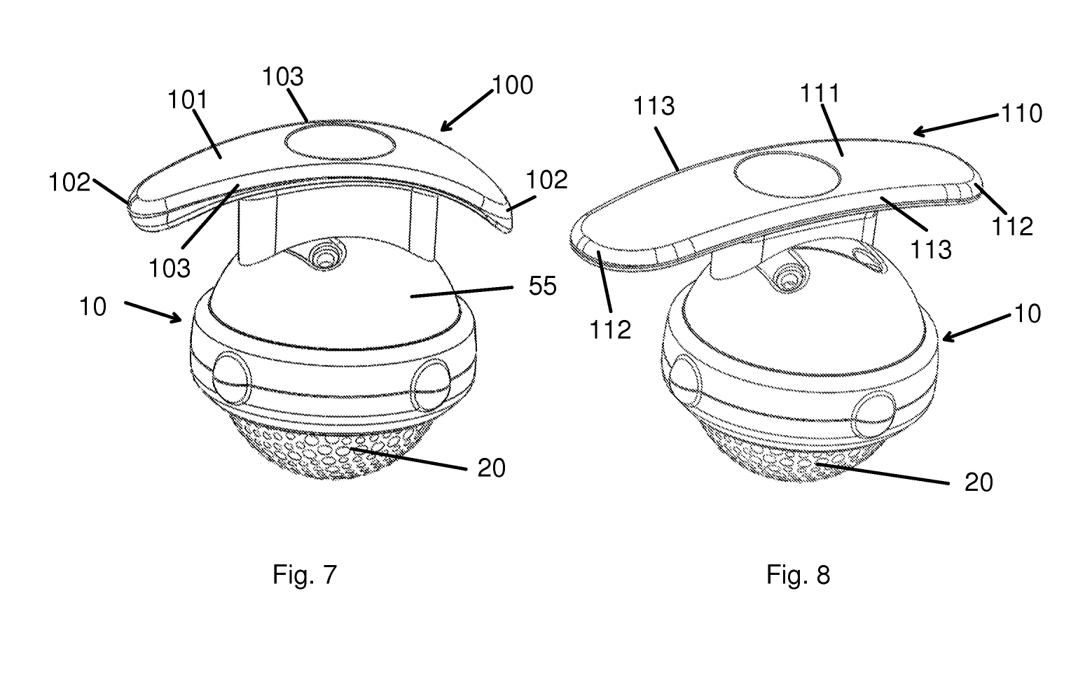

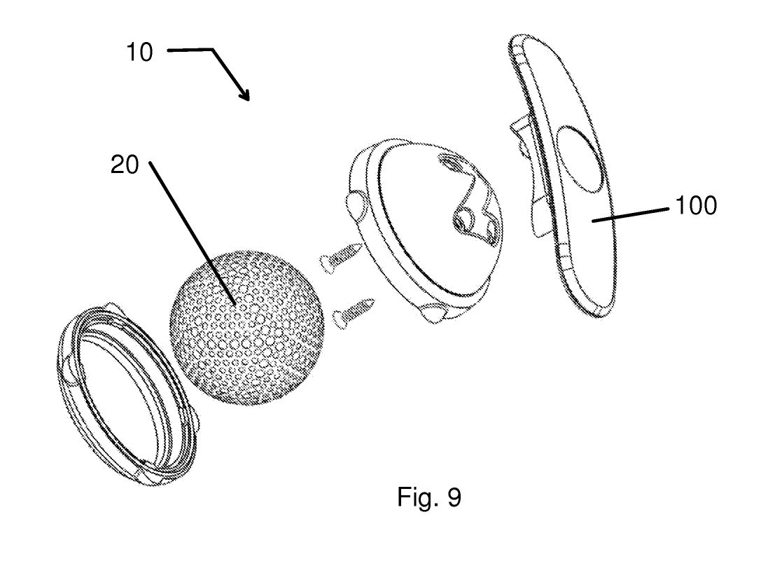

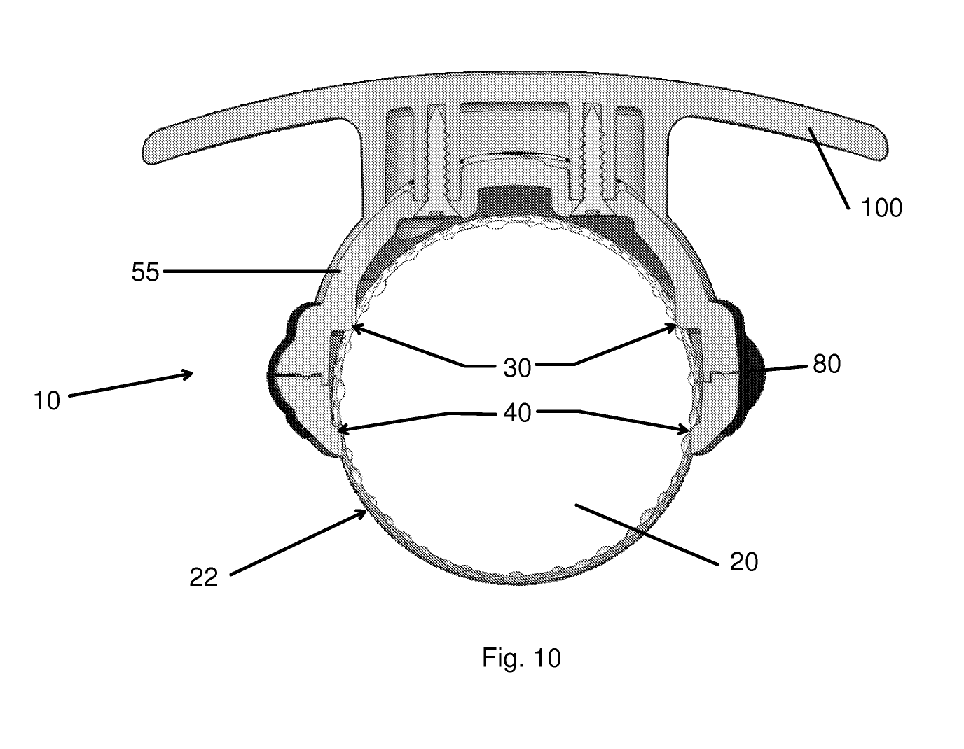

Adding a dorsal handle 100 creates yet another grip profile. But in addition, the winged tips 102 of the dorsal handle 100 in FIG. 7 can add an additional massage tool. One embodiment of the dorsal handle 100 has multiple ‘arc’ contours 101 that emulate larger diameter surfaces for larger muscle groups and fascia, as well as an end surface that has been designed for deep muscle tissue work. Adding the preferred dorsal handle 100 as shown in FIGS. 7, 9 & 10, provides a range of differing grip possibilities for large and small hands as well as multiple surfaces, edges, and faces which multiply the therapy value and function across the physical/massage therapy spectrum.

Another alternate embodiment is to connect an offset/eccentric dorsal handle 110. Contrasting FIG. 7 with FIG. 8 illustrates how the dorsal handle can be centric or offset to achieve different massage options. Both offset and centric dorsal handles designs 100 & 110 may have edges/surfaces 103 & 113 that facilitate ‘muscle scraping’ type of therapy.

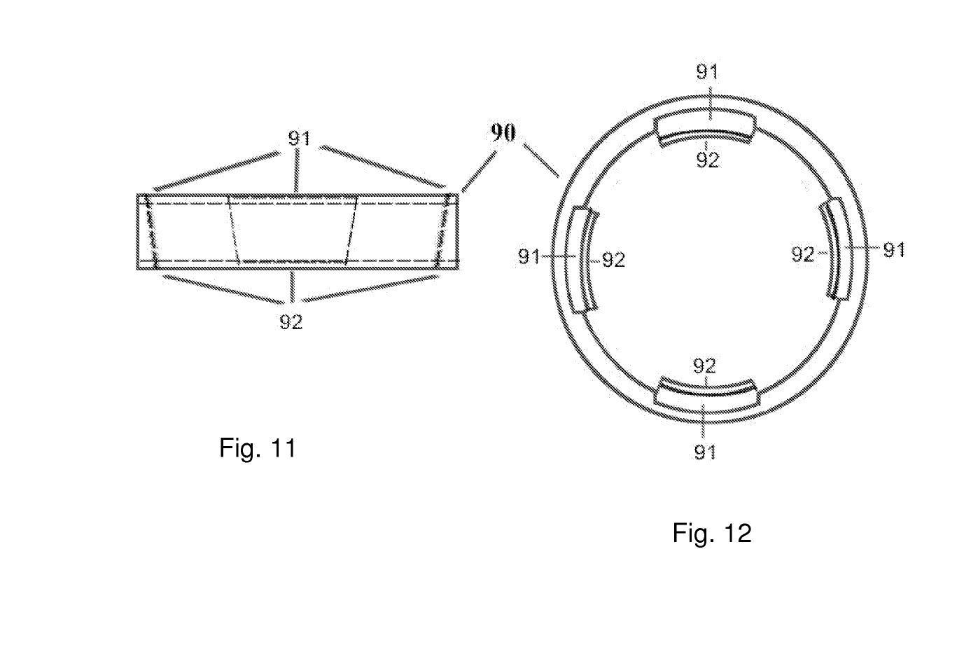

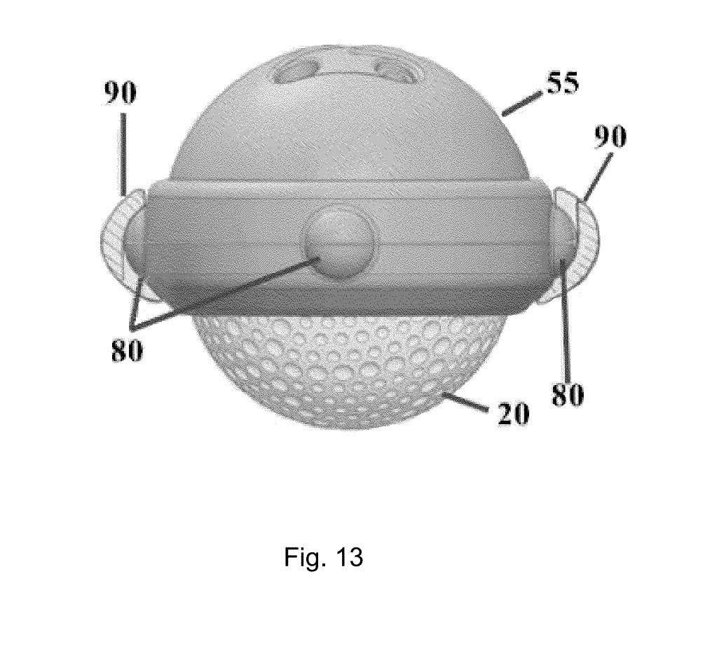

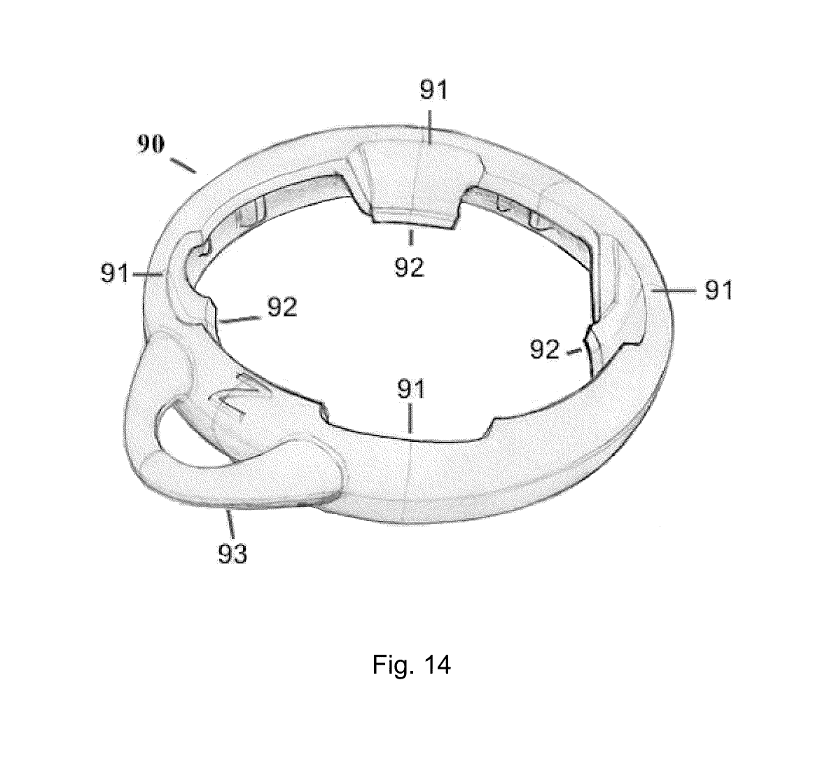

Another alternate embodiment is to create domed protrusions (or knobs) 80 on the housing 55. The domed protrusions have multiple purposes: (1) each domed ‘knob’ is a pressure point therapy surface, and (2) the knobs 80 can create a mounting point for adding future devices via a lock-ring assembly. A preferred embodiment of the lock-ring assembly 90 is shown in FIGS. 11-14. As illustrated in FIGS. 11-14, the preferred lock-ring assembly 90 comprises mated coves 91 for rotationally accepting the domed protrusions 80. Retainer 92 prevents over-rotation of the lock-ring assembly 90 relative to the housing 55. Carabiner attachment loop 93 can be added for additional functionality. Those in the art will recognize many other ways to configure a suitable lock-ring assembly 90.

Using knobs 80 as means to interface with lock-ring assembly 90 creates the additional possibilities of incorporating massager 10 as a building block for a variety of additional devices, including a foot massage floor stand, connector handle for multiple ball massage, back “scratcher” devices.

While the invention has been described by means of specific embodiments, numerous modifications and variations could be made thereto by those ordinarily skilled in the art without departing from the scope and spirit of the invention set forth in the claims.

1. An improved rolling ball massager comprising,
a rigid sphere having an imaginary plane running through a center point of the sphere;
a top bearing ring located above the imaginary plane;
a bottom bearing ring located below the imaginary plane; and
a structure concentrically holding the two rings a fixed distance apart from each other,
wherein the rigid sphere is held by and can rotate between the top bearing ring and the bottom bearing ring when a user grips the structure and massages a patient with an exposed surface of the rigid sphere.

2. The improved rolling ball in claim 1 further comprises a cap coupled to the top bearing ring and overhanging the rigid sphere.

3. The improved rolling ball in claim 2 further comprises a handle removably attached to the cap for the user to grip.

4. The improved rolling ball in claim 3, wherein the handle is concentric with the structure.

5. The improved rolling ball in claim 3, wherein the handle is eccentric with the structure.

6. The improved rolling ball in claim 3, wherein the handle further comprises a wing.

7. The improved rolling ball in claim 3, wherein the handle further comprises a curved contour.

8. The improved rolling ball in claim 3, wherein the handle further comprises a muscle-scraping edge.

9. The improved rolling ball in claim 1, wherein the structure further comprises a drain hole.

10. The improved rolling ball in claim 1, wherein the structure further comprises a protrusion.

11. The improved rolling ball in claim 13 further comprises a member coupled to the structure by rotationally accepting the protrusion with a cove on the member.

12. The improved rolling ball in claim 14, wherein the member further comprises a retainer for holding the member in place relative to the structure.

13. The improved rolling ball in claim 14, wherein the member further comprises a loop.

14. An improved rolling ball massager comprising,
a rigid sphere having an imaginary plane running through a center point of the sphere;
a top bearing ring located above the imaginary plane;
a bottom bearing ring located below the imaginary plane;
a structure concentrically holding the two rings a fixed distance apart from each other;
a cap coupled to the top bearing ring and overhanging the rigid sphere; and
a handle removably attached to the cap for a user to grip, wherein the rigid sphere is held by and can rotate between the two rings when the user massages a patient with an exposed surface of the rigid sphere.

15. The improved rolling ball in claim 16, wherein the handle further comprises a wing.

16. The improved rolling ball in claim 16, wherein the handle further comprises a muscle-scraping edge.

17. The improved rolling ball in claim 16, wherein the handle further comprises a curved contour.

18. The improved rolling ball in claim 16, wherein the structure further comprises a protrusion.

19. A method of assembling an improved rolling ball massager comprising:
providing a rigid sphere having an imaginary plane running through a center point of the sphere;
placing a top bearing ring above the imaginary plane;
placing a bottom bearing ring below the imaginary plane;
holding the rigid sphere between the two rings but allowing the rigid sphere to rotate; and
providing a structure that concentrically holds the two rings a fixed distance apart from each other and can be gripped by a user to massage a patient with an exposed surface of the rigid sphere.

20. The method of claim 19 further comprises:
coupling a cap to the top bearing ring wherein the cap overhangs the rigid sphere; and
removably attaching a handle to the cap for the user to grip.
